(19) United States
(12) Patent Application Publication
(10) Pub. No.: US 2006/0288373 A1
(43) Pub. Date: Dec. 21, 2006

(54) System and method for communicating with a display device via a network

(76) Inventors: Kevin Lloyd Grimes, Fishers, IN (US); Renee Angela, Indianapolis, IN (US)

Correspondence Address: THOMSON LICENSING INC., PATENT OPERATIONS, PO BOX 5312, PRINCETON, NJ, 08543-5312, US

(21) Appl. No.: 10/555,526

(22) PCT Filed: May 4, 2004
(86) PCT No.: PCT/US04/13859

§ 371 Date: Nov. 3, 2005

Related U.S. Application Data
(60) Provisional application No. 60/467,928, filed on May 5, 2003.

(51) Int. Cl. H04N 7/16

(52) U.S. Cl. 725/62

(57) ABSTRACT

A system and corresponding methods are provided for enabling communication with an electronic apparatus via a network. The system comprises: a first device for transmitting a communication comprising identification parameters associated with a second device, wherein the communication is compatible with a communication protocol of a first electronic apparatus; a first electronic apparatus for communicating with the second device, wherein first electronic apparatus comprises a first interface for wirelessly communicating with the first device and a second interface for communicating with the second device via a network; and a second device for communicating with the first electronic apparatus, with the second device communicating the first electronic apparatus via the network.

### FIELD OF THE INVENTION

The present invention relates to communicating with an electronic apparatus and, more particularly, to a system and method for communicating with a video display device via a network.

### BACKGROUND OF THE INVENTION

Electronic appliances such as video display devices may be controlled via a computer through a network connection. Adjustments such as changing the volume or color alignment are no longer performed by adjusting a knob on a video display device such as a television rather they are performed digitally by interfacing with a menu on the video display device's screen or via an infrared remote. The introduction of computer controlled video display devices has enhanced the features and capabilities of modern video display devices. For example, computer controlled video display devices can be electronically diagnosed for service or repair, subjected to automated testing and controlled to perform a variety of functions. In addition, these video display devices can be connected together via a local area network (LAN) using networking protocols such as Ethernet, token ring, asynchronous transfer mode (ATM), etc.

In order to perform a desired function such as the servicing or testing a computer controllable video display device, a number of communication techniques have been developed by video display device manufacturers and service providers to realize such operations. These techniques typically require a computer and an infrared transmitter, which are used by a service technician, to communicate with a computer controlled video display device. The communication channel between the computer and the video display device sometimes takes place over an Ethernet connection. For security reasons, however, the computer controlled video display device will typically only allow access to a computer that is compatible with the video display device, thereby, preventing an un-authorized user from gaining access to the video display device.

In order to communicate with a video display device via a computer, a service technician having knowledge of the video display device's IP address and port reconfigures the IP address and port of their computer. This process can be somewhat prohibitive due to a lack of networking knowledge by the service technician and the proliferation of operating systems that preclude the ability to automate the configuration and restoration of the computer's IP address. In addition, current communication techniques prevent a service technician from communicating with more than one video display device at a time over a network.

Accordingly, there is a need for a system and method of communicating with one or more electronic appliances, such as a video display device, via a network where a service technician does not need extensive knowledge of networking environments.

### SUMMARY OF THE INVENTION

In one embodiment of the present invention, a method for communicating with an electronic apparatus via a network is presented. The method comprises the steps of: receiving a communication comprising identification parameters associated with a computer, wherein the communication is compatible with a communication protocol of a first electronic apparatus; transmitting a request to establish communication with the computer associated with the received identification parameters, wherein the request is transmitted via a network; receiving a response to the request, wherein the response attempts to establish communication between the computer and the first electronic apparatus, wherein the response is transmitted via the network; and validating the response to the request to ensure that the computer to which the request to establish communication was transmitted is the computer associated with the received identification parameters. A system for implementing the described method is also disclosed.

In another embodiment of the present invention, a method for communicating with a media server for receiving media objects based on the properties of a display device is presented. The method determines the type of display technology used for a display device whereby the display device receives a media object that is optimized for visual playback for that display device. Display devices with different display technologies receive different media objects generated from the same source material.

### BRIEF DESCRIPTION OF THE DRAWINGS

The present invention may be better understood in accordance with the following exemplary figures, in which:

FIG. 1 is a block diagram of a system for communicating with an electronic apparatus according to an exemplary embodiment of the present invention;

FIG. 2 is a block diagram of a personal computer (PC) for use with the present invention;

FIG. 3 is a block diagram of a control system of a video display device for use with the present invention;

FIG. 4 is a flowchart showing an operation of a system for communicating with a video display device according to an exemplary embodiment of the present invention; and

FIG. 5 is a flowchart showing an operation of a system for communicating with a video display device depending on the properties of the video display device according to an exemplary embodiment of the present invention.

### DETAILED DESCRIPTION OF EXEMPLARY EMBODIMENTS

As used herein, the term “media object” includes audio, video, textual, multimedia data files, and streaming media files. Multimedia objects comprise any combination of text, image, video, and audio data. Streaming media comprises audio, video, multimedia, textual, and interactive data files that are delivered to a user via the Internet, satellite or other communications network environment and begin to play on the user's computer/device before delivery of the entire file is completed. Media objects may be transmitted over any communications network including via the Internet, satellite (digital satellite system, digital video system-satellite), cable, digital subscriber line, T1 lines, wireless network, or other delivery systems capable of delivering media objects.

Examples of the content of media objects include songs, political speeches, news broadcasts, movie trailers, movies, television show broadcasts, radio broadcasts, financial conference calls, live concerts, web-cam footage, and other special events. Media objects are encoded in various formats including REALAUDIO®, REALVIDEO®, REALMEDIA®, APPLE QUICKTIME®, MICROSOFT WINDOWS® MEDIA FORMAT, QUICKTIME®, MPEG-2 (MOTION PICTURE EXPERTS GROUP) VIDEO COMPRESSION, MPEG-4 VIDEO AND/OR AUDIO COMPRESSION, JOINT VIDEO TEAM COMPRESSION FORMAT (MPEG-4 part 10 AVC, H.264), MPEG-2 LAYER III AUDIO, MP3®. Typically, media objects are designated with extensions (suffixes) indicating compatibility with specific formats. For example, media objects (e.g., audio and video files) ending in one of the extensions, .ram, .rm, .rpm, are compatible with the REALMEDIA® format. Some examples of file extensions and their compatible formats are listed in the Table 1. A more exhaustive list of media types, extensions and compatible formats may be found at http://www.bowers.cc/extensions2.htm.

TABLE 1

| Format | Extension |
|---|---|
| REALMEDIA ® | .ram, .rm, .rpm |
| APPLE QUICKTIME ® | .mov, .qif |
| MICROSOFT WINDOWS ® | .wma, .cmr, .avi |
| MEDIA PLAYER | |
| MACROMEDIA FLASH | .swf, .swl |
| MPEG | .mpg, .mpa, .mp1, .mp2 |
| MPEG-2 LAYER III Audio | .mp3, .m3a, .m3u |

The illustrated embodiments of the invention operate with media objects that contain video data for presenting a video presentation of “near to motion picture quality”. Such media objects may be encoded in a variety of formats such as MPEG-2 (Motion Picture Standards Group Standard ISO/IEC 13818-1:2000) and ITU-T H.264/MPEG AVC (ISO/IEC 14496-10), or may be uncompressed video. It is noted that the invention also operates with over the air broadcasted programming such as used for Advanced Television System (ATSC) or Digital Video Broadcasts (DVB) compliant video signals.

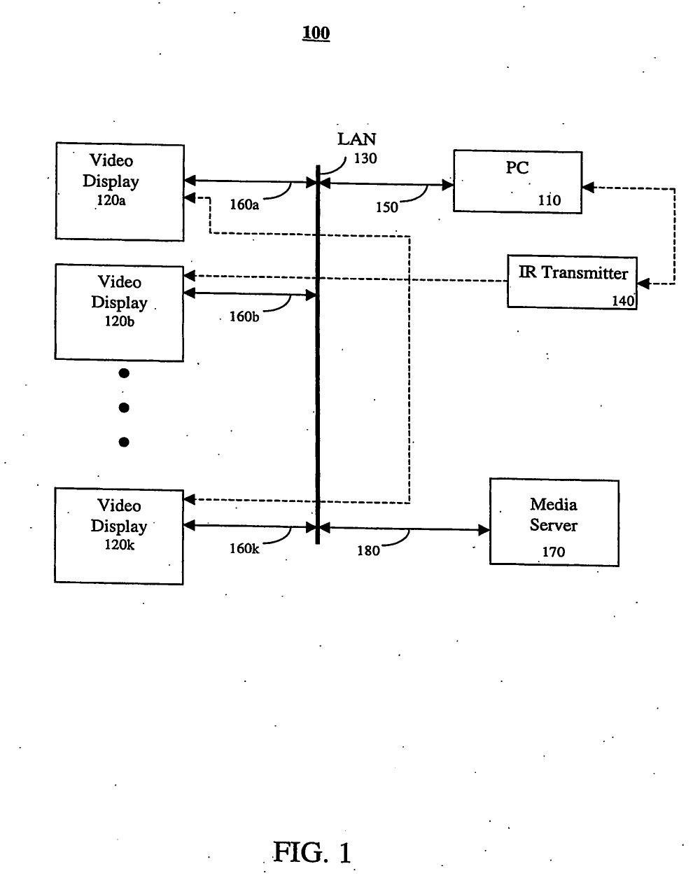

FIG. 1 is a block diagram of a system 100 for communicating with an electronic apparatus according to an exemplary embodiment of the present invention. As shown in FIG. 1, the system 100 includes, inter alia, a personal computer (PC) 110, electronic appliances, for example, video display devices 120a, b . . . k, an infrared (IR) transmitter 140, and media server 170. The PC 110 and the video display devices 120a, b . . . k, are connected together over a local area network (LAN) 130 via a pair of connection means 150, 160a, b . . . k, and connection means 180.

The PC 110 may be a portable or laptop computer, a personal digital assistant (PDA), etc. that is capable of communicating with the video display devices 120a, b . . . k using a communication protocol such as a factory defined or proprietary protocol that is capable of supporting a feature set of one of the video display devices 120a, b . . . k. The video display devices 120a, b . . . k may be digital video display device having enhanced-definition television (EDTV) and high-definition video television (HDTV) capabilities, and plasma, liquid crystal, organic light emitting, or cathode ray tube (CRT) displays, etc. The video display devices 120a, b . . . k are also capable of communicating with a device such as the PC 110 and IR transmitter 140 via external interfaces, such as an interface menu at the video display devices 120a, b . . . k, the connection means 150, 160a, b . . . k or an infrared receiver. The IR transmitter 140 may be a common video display device remote control such as a universal remote control having infrared transmission capabilities. Video display devices 120a, b . . . k, are also preferably capable of decoding received media objects using a media player application such as REALPLAYER or WINDOWS MEDIA PLAYER.

It is to be understood, that although the electronic apparatus of FIG. 1 is illustrated as one of several video display devices 120a, b . . . k, the electronic apparatus can be any number of network devices such as satellite receiver, digital video disk (DVD) player, stereo equipment, etc., other personal computers, set top boxes, and which can be connected over a network and accessed via a client-server or peer to peer architecture.

The LAN 130 may use networking protocols such as Ethernet using a 10 BaseT, 100 BaseT or 1000 BaseT standard, token ring, asynchronous transfer mode (ATM), etc. or any networking protocol that allows for automatic configuration and restoration of a video display device's internet protocol (IP) address. The connection means 150, 160a, b . . . k, and connection means 180, may be a twisted pair cable capable of connecting the PC 110 and video display devices 120a, b . . . k over, for example, an Ethernet network. The connection means 150, 160a, b . . . . k, and connection means 180 may also be terminated with RJ-45 style Ethernet connectors, although other connectors may be used.

It is also contemplated that connection means 150 and 180 may be a connection to LAN 130 through the use of a network fabric, such as the Internet. The use the network fabric may be any type of network known in the art. Preferably, such a network is capable of accommodating multiple connections between resources at a server side of a server and at the client side of a client, such connections being UDP based, TCP/IP based, or a mixture of both. The bandwidth accommodated by network 150 is preferably a large bandwidth connection such as a T1 connection (1.5 Megabits per second, Mbps), T3 connection (45 Mbps), DS3 connection (45 Mbps), OC3 connection (155 Mbps), OC12 (248000 Mbps), and the like.

Media server 170 is a storage device such as a matrix of hard drives having a capacity of Terabytes and/or Gigabytes capable of storing multiple media objects. Media server 170 is also capable of delivering such media objects to display devices 120a . . . k through connection means 180 via LAN 130.

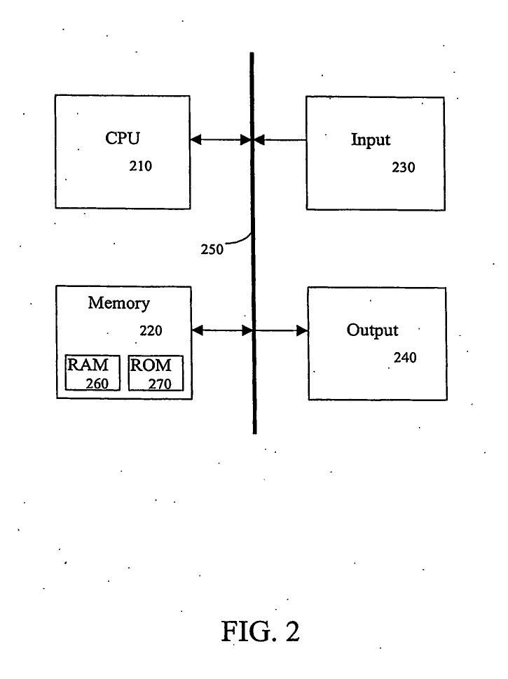

FIG. 2 is a block diagram of a PC 200 for use with the present invention. The PC 200 may be used in place of or in conjunction with the PC 110 of FIG. 1. The PC 200 includes a central processing unit (CPU) 210 and a memory 220 and, is connected to an input 230 and an output 240 via a data bus 250. The memory 220 includes a random access memory (RAM) 260 and a read only memory (ROM) 270. The memory 220 can also include a database, disk drive, tape drive, etc., or a combination thereof. The RAM 260 function as a data memory that stores data used during execution of a program in the CPU 210 and is used as a work area. The ROM 270 functions as a program memory for storing a program executed in the CPU 210. The input 230 is constituted by a keyboard, mouse, connecting means, input device, etc. and the output 240 is constituted by a liquid crystal display (LCD), CRT display, printer, connecting means, etc.

It is to be understood that the CPU 210 and memory 220 include data associated with communicating via a number of communication protocols used by an electronic apparatus, for example, the video display devices 120a, b . . . k of FIG. 1. The data associated with communicating with the video display devices 120a, b . . . k includes, inter alia, identification parameters such as the PC's 200 IP address, port and password. Further, the PC 200 includes software stored in its memory 220 to provide service technicians with a method to diagnose and repair the video display devices 120a, b . . . k. This software may be of the type commonly used by video display device service technicians such as, CHIPPER CHECK™ available from Thomson, to service and diagnose the problems of video display devices.

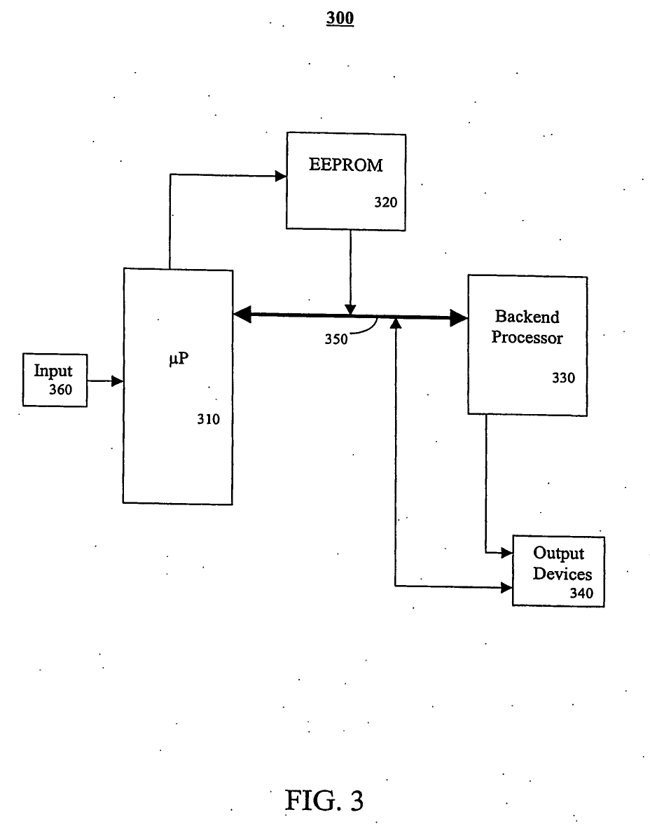

FIG. 3 is a block diagram of a control system of a video display device 300 for use with the present invention. The control system 300 includes, inter alia, a microprocessor (μP) 310, an electrically erasable programmable read only memory (EEPROM) 320 and output devices 340. The microprocessor 310, EEPROM 320 and output devices 340 communicate with each other via a data bus 350. An input 360 is connected to the microprocessor 310 and, a backend processor 330 is connected to the data bus 350.

The microprocessor 310 communicates with the output devices 340 such as light emitting diodes (LEDs), digital video interfaces (e.g., high definition multimedia interface (HDMI) 1394), infrared transmitters, etc. and the backend processor 330 to control a digital video display device such as one of the video display devices 120a, b . . . k of FIG. 1. The microprocessor 310 also communicates with the backend processor 330 to perform backend processing such as video processing and, the backend processor 330 is also coupled to the output device 340 to control, for example, display parameters and to improve video quality. The microprocessor 310 also receives input 360 from a video display device's front panel, remote control, EEPROM 320 and any of the devices that are connected to the data bus 350. The EEPROM 320 stores values used by the microprocessor to control one of the video display devices 120a, b . . . k. These values may include, for example, alignment information, initialization signals and customer information. Exemplary customer information may include a channel scan list, color, brightness and volume levels.

The EEPROM 320 includes information such as values associated with one of the video display devices 120a, b . . . k that were stored in the EEPROM 320 when one of the video display devices 120a, b . . . k were made. The EEPROM 320 also has the ability to have information written to it from an external device such as the PC 110 or IR transmitter 140. Thus, for example, the EEPROM 320 can store identification parameters written to it from the PC 110. These parameters may include the PC's 110 IP address and port, thereby allowing the PC 110 to communicate with one of the video display devices 120a, b . . . k. Once the PC 110 is in communication with one of the video display devices 120a, b . . . k, the PC's 110 service and testing software sends commands to one of the video display devices 120a, b . . . k to perform a number of operations on one of the video display devices 120a, b . . . k.

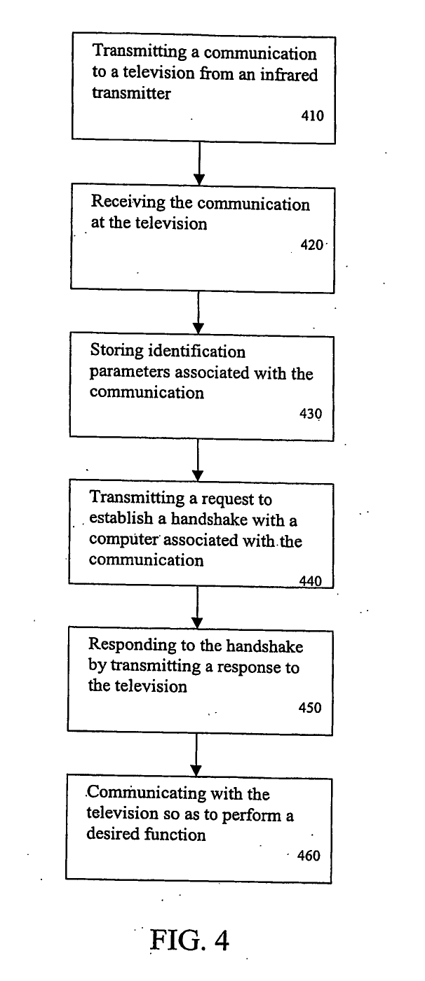

FIG. 4 is a flowchart showing an operation 400 of a system for communicating with a video display device according to an exemplary embodiment of the present invention. As shown in FIG. 4, a service technician transmits a communication to, for example, a video display device 120a of FIG. 1 (step 410). The communication is transmitted by, for example, the IR transmitter 140 of FIG. 1. It is to be understood that the communication may also be transmitted to the video display device 120a by accessing an interface menu on the video display device's 120a screen and inputting the communication. The communication includes parameters associated with identifying a PC, for example, PC 110 of FIG. 1 to the video display device 120a. These parameters include, inter alia, the PC's 110 IP address and port. It should be understood that the communication is transmitted via a factory defined protocol or a proprietary protocol that is compatible with the video display device 120a After the communication has been transmitted, it is received by the video display device 120a (step 420). An infrared receiver located at the video display device 120a receives this communication. Upon receipt of the communication, the video display device 120a stores the identification parameters associated with the communication in a memory, such as the EEPROM 320 of FIG. 3 (step 430). This occurs, because the communication was transmitted via a protocol used by the video display device 120a that is considered safe to communicate with, thereby permitting data associated with the communication to be stored. Once the identification parameters, which include the PC's 110 IP address and port, are stored in the video display device's 120a memory, the video display device 120a transmits a signal to the PC 110 (on the port specified in the communication of step 410) in an effort to establish communication between the video display device 120a and the PC 110 (step 440). In other words, the video display device 120a is attempting to complete a handshake with the PC 110 by transmitting a message via a handshaking protocol telling the PC 110 that it has received the PC's 110 identification information and is ready to receive further communication from the PC 110.

Upon receipt of the video display device's 120a request to establish further communication, the PC 110 responds to the request by transmitting a communication indicating that it is the device with which the video display device 120a should be communicating (step 450), thereby completing the handshake. This handshake assures both the video display device 120a and the PC 110 that they are connected to each other and not an imposter or an unauthorized user and, is possible because the PC's 110 IP address and port were programmed into the memory of the video display device 120a by the service technician in step 410. It is to be understood that in this configuration the video display device 120a functions as a client and the PC 110 functions as a remote server in client-server software architecture.

After a secure communication channel between the video display device 120a and the PC 110 is established, the PC 110 may then communicate with the video display device 120a to perform a desired function on the video display device related to, for example, servicing or testing (step 460). The function to be performed may be one of a color, geometry, video, stereo or picture-in-picture (PIP) alignment, or an adjustment to various calibration values associated with picture quality, etc.

In an alternative embodiment of the present invention, the PC 110 of FIG. 1 can communicate with more than one electronic apparatuses, such as the video display devices 120a, b . . . k. This is accomplished by transmitting the PC's 110 IP address and port to, for example, the video display device 120b, when the PC 110 is already in communication with the video display device 120a (by performing the same or similar process as described above in steps 410-450 of FIG. 4). In order to accomplish this, the PC 110 assigns a different port to the video display device 120b. Once the steps 410-450 are completed the PC 110 may then begin to perform a desired function on the video display device 120b, while still performing desired functions on the video display device 120a. When performing functions on more than one video display device, the PC 110 can have separate windows for each video display device on an output such as an LCD display.

It is to be further understood that the PC's 110 IP address and port (for video display device 120b) can be transmitted to the video display device 120b at the same time the PC 110 IP address and port (for video display device 120a) are transmitted to the video display device 120a. Thereby, enabling a service technician to connect and then communicate with more than one video display device simultaneously.

By communicating with more than one video display device the PC 110 offers flexibility to a service technician, because they are not limited to performing functions on one video display device at a time. In addition, by having control of more than one video display device or electronic apparatus a service technician and/or authorized user of the present invention may for example, simultaneously turn multiple video display devices off or on, change channels, volume, etc. or view, for example, the same movie on several DVD players.

In an alternative variant of the present invention a computer's identification information may be transmitted wirelessly from a transmitter using Bluetooth, Institute of Electrical and Electronics Engineers (IEEE) 802.11 or Infrared Data Association (IrDA) wireless transmission technologies.

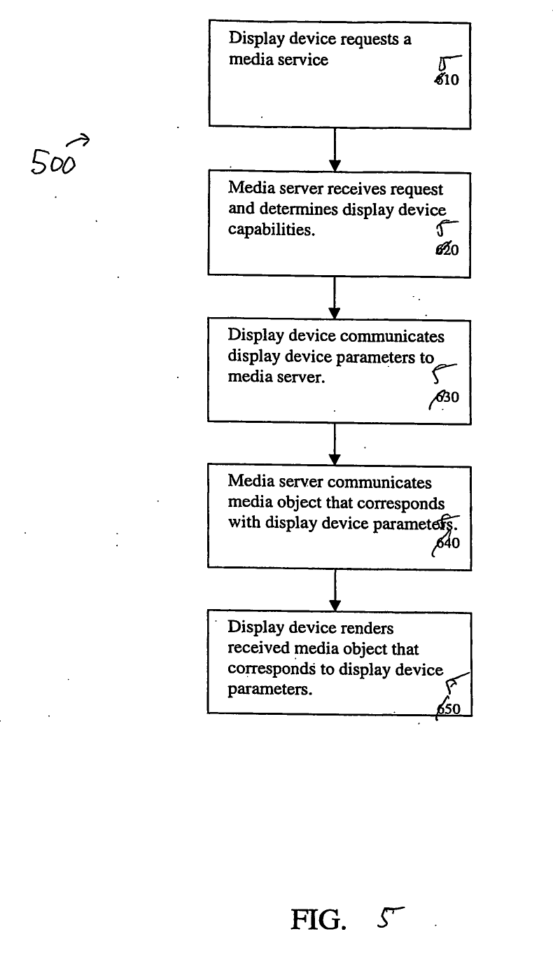

FIG. 5 is a flowchart disclosing a method 500 for communicating with a video display device to receive a media object depending on the properties of the video display device. Specifically, it is recognized that with the development of video display device technologies such as OLED, plasma, LCD, and the like, there may be variances in the rendering of media service on a display device. For example, a media service encoded with MPEG-2 video codec may be of a motion picture quality when displayed on a Cathode Ray Tube (CRT) display device but may be blurred when rendered on an OLED display device.

The cause for the problem given in the example above pertains to encoding methodology used for encoding a media service. Typically, encoders use compression techniques that reduce the size of encoded media object from the original source material. For example, an MPEG-2 based encoder accomplishes a 40 to 50:1 type of compression when used to encode video based source material. Part of the compression takes advantage of techniques known as psychometric functions that are related to how human beings perceive media objects visually and aurally, where a percentage of data can be eliminated from source material without a human perceiving the loss of such data. The development of MPEG-2 and other encoding techniques are developed with humans being tested to determine what visual or audio information needs to be kept and what can eliminated from source material, see ITU Recommendation BT.500-8, “Methodology for Subjective Assessment of the Quality of Television Pictures,” 1998, for background about testing human visual perception.

Additionally with the development of new display technologies, a human may be able to notice artifacts due to an encoding technique selected (for example, on an OLED display device) that would not be as apparent on a second display device (a CRT display). Continuing with the present example, it may be the case that a human would notice artifacts of the macroblocks used for MPEG-2 encoded video on an OLED display device that would not be apparent to a human on the CRT. This may due to the underlying physical properties of the display device technology used to render a video image. Hence, the screen refresh techniques for the CRT may be better at hiding such artifacts of MPEG-2 than the screen refresh techniques for an OLED display device.

Recognizing these deficiencies of human perception, the present invention discloses architecture for delivering media objects in an encoding format optimized for display device used to render such media object. For an illustrative embodiment of the present invention by referring to FIG. 1, video display device 120a represents a CRT based video display device and video display device 120b is an OLED display device.

Both display devices are connected to media server 170 through a connection means 180.

In step 510, display device 120a requests a media object from media server 170. For example, the request for a media object is for a movie that is delivered through a video on demand system or a media object delivered as streaming media through the Internet. Media server 170 receives this request, in step 520, and determines the capabilities of display device 120a. In the preferred embodiment of the invention, display device 120a transmits identification parameters as part of device parameters that identify the display device technology used for that device when rendering a media service. For example, the display device 120a transmits metadata identifying the display device as a CRT based television. Table II presents an exemplary embodiment of a metadata field DISPLAYDEVICE and corresponding values that may be used to identify a display device technology using an Extensible Markup Language format. For example, metadata received as <DISPLAYDEVICE>CRT </DISPLAYDEVICE>represents a CRT based display device technology. Other metadata formats may be used, in accordance with the principles of the present invention.

TABLE 2

| DISPLAY TECHNOLOGY | VALUE |
|---|---|
| Cathode Ray Tube | CRT |
| Organic Light Emitting Diode | OLE |
| Liquid Crystal Display | LCD |
| Liquid Crystal on Silicon | LCO |
| Digital Light Projector | DLP |
| Plasma | PLA |

Alternatively, based on the request by display device 120a for a media object, the IP and/or port address of display device 120a is transmitted as part of the request. Media server 170 preferably has a database that contains information that identifies the technology used for identifying the display device by the IP address and/or port address information that is part of the request. This information could be entered in by a user and stored by media server 170 when registering the display device through a network connection.

Step 530 presents an optional step where display device 120a communicates identification parameters to media server 170. This communication is typically in response to a query made by media server 170 requesting the display technology used for the display device. Preferably, this communication of identification parameters is similar to the metadata presented in TABLE 2, although other formats of identification parameters may be used.

In response to the identification parameters received by media server 170, in step 540 the media server communicates a media object to video display 120a that corresponds to the display technology used for the display device. In the preferred embodiment, media server 170 utilizes a lookup table or database entry that designates a display technology to an encoding technique that has been predefined as producing an optimal video image for the display device technology. For example, for a CRT it may be determined that MPEG-2 encoded media object produces an optimal video presentation compared to an OLED display where a Windows Media 9 encoded media object may produce the optimal video presentation. Any encoding format may be selected, in accordance with the determinations made by the operator of media server 170. These determinations may change as new encoding techniques are created as with further improvements in display device technologies.

In the preferred embodiment, media server 170 stores multiple versions of the same source material as media objects encoded in different formats. In the present example, media server 170 would store the source material of a movie as a media object encoded in MPEG-2 format and a media object encoded in Windows Media 9 format. Alternatively, media server 170 would encode the source material of a media object into the appropriate format in real time or in close to real time using an encoder, in accordance with the designated encoding format for a display technology as described above.

Media server 170 then transmits the MPEG-2 encoded media object to display device 120a that is designated as a CRT, for this example. The media object is transmitted through connection means 180 and LAN 130 to display device 120a. If display device 120b requests the same movie, media server 170 would transmit the Windows Media 9 encoded media object to the OLED based display device, as specified above. Other encoding formats and display devices are to be considered in accordance with the principles of the present invention.

In addition, for each format of a media object, visual attributes of the source material used to generate a media object are to be modified as to produce an optimal video picture for a specific display technology. Visual attributes to be modified include color, tint, contrast, hue, saturation, brightness, frame rate, lines per field, pixels, and the like. The visual attributes are selected and modified in accordance with experimentally determined parameters for providing the optimal viewing video on a display device for a particular technology.

In step 550, the display device receiving the media object renders the object as video. In the present example, each display device has a decoder capable of decoding a received media service. Hence, display device 120a has an MPEG-2 video decoder and display device 120b has a Windows Media 9 video decoder. The decoder or decoders for a display device are to be selected in accordance with the format of the media objects to be decoded by the display device.

In an alternative embodiment of the present invention, sub-channels or “minor” channels of a multi-casted digital broadcast may be used to transmit multiple versions of a media object as used for an ATSC or DVB based television system. Specifically, a sub-channel for a digital broadcast system may be designated to carry programs for a display device of a first technology and utilize a second sub-channel to carry programs for a display device of a second technology, where the media object is generated from the same source material. For example, a program transmitted on a first sub-channel may have the gamma values of the color of the programming be modified for display on a plasma device compared to a program carried on a second sub-channel where the programming would be color corrected for display on a LCD screen. Other attributes of programming may be modified in accordance with the principles of the present invention.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

It is to be further understood that, because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

1-44. (canceled)

45. A method for producing a media object comprising the steps of:
determining a display parameter related to the display technology used for the display device;
generating a media object corresponding to a display technology in response to said parameter.

46. The method of claim 45, wherein said display parameter is communicated to a server that in response to said display parameter transmits back data that is generated as said media object.

47. The method of claim 45, wherein said display parameter indicates a display technology used is at least one of: a cathode ray tube, organic light emitting diode, liquid crystal display, liquid crystal on silicon, digital light project, and plasma.

48. The method of claim 47, wherein said media object is encoded in a format optimized for said display technology.

49. The method of claim 48, wherein the media object has a visual attribute modified for said display technology, wherein said visual attribute is changed when said media object is to be displayed on a display device using a different display technology.

6. The method of claim 46, wherein said media object is transmitted on a sub-channel of a digital television broadcast system and the changed media object is transmitted on a different sub-channel.

50. A method for transmitting a media object comprising the steps of:
determining a device display parameter related to a display technology used for a display device, wherein the parameter is received as part of a request for a media object; and
transmitting the media object to the display device, wherein the media object corresponds to the display technology used for the display device.

51. The method of claim 50, wherein said parameter indicates the display technology used is at least one of: a cathode ray tube, organic light emitting diode, liquid crystal display, liquid crystal on silicon, digital light project, and plasma.

52. The method of claim 51, wherein said media object is encoded in a format optimized for a display technology.

53. The method of claim 52, wherein the media object has a visual attribute modified for said display technology, wherein said visual attribute is changed when said media object is to be displayed on a display device using a different display technology.

54. The method of claim 53, wherein said media object is transmitted on a sub-channel of a digital television broadcast system and said changed media object is transmitted on a different sub-channel.
